(19) United States
(12) Patent Application Publication
(10) Pub. No.: US 2019/0140414 A1
(43) Pub. Date: May 9, 2019

(54) ANTI-REFLECTION COATED PUMP DUMPS

(71) Applicants: Shaheed Rahim, Roslindale, MA (US); Jason E. Langseth, Malden, MA (US)

(72) Inventors: Shaheed Rahim, Roslindale, MA (US); Jason E. Langseth, Malden, MA (US)

(21) Appl. No.: 16/057,288

(22) Filed: Aug. 7, 2018

Related U.S. Application Data
(60) Provisional application No. 62/541,984, filed on Aug. 7, 2017.

(51) Int. Cl. H01S 3/06; H01S 3/067; H01S 3/00; H01S 3/091

(52) U.S. Cl. CPC H01S 3/0625; H01S 3/091; H01S 3/0064; H01S 3/06729

(57) ABSTRACT

A pump dump or cladding mode stripper is used to remove unwanted light from the cladding of an optical fiber. Conventional pump dumps include high-index polymer coatings and roughened cladding outer surfaces. Unfortunately, high-index polymer coatings absorb the stripped light, so they melt or burn at high optical powers, and roughening the cladding's outer surface makes the fiber too brittle for many applications. Fortunately, it is possible to frustrate total internal reflection at the interface between the cladding and air by texturing the cladding's outer surface with irregularly distributed, shaped, and size features that are less than a micron in size. These features don't absorb light and are too small to make the fiber brittle, yet they still cause incident pump light to exit the optical fiber. These qualities make them suitable for dumping high-power pump beams from the claddings of fiber amplifiers and fiber lasers.

### CROSS-REFERENCE TO RELATED APPLICATION(S)

This application claims the priority benefit, under 35 U.S.C. § 119(e), of U.S. Application No. 62/541,984, entitled “AR Coated Pump Dumps,” which was filed on Aug. 7, 2017, and is incorporated herein by reference in its entirety.

### GOVERNMENT SUPPORT

This invention was made with Government support under Contract No. FA8721-05-C-0001 awarded by the U.S. Air Force. The Government has certain rights in the invention.

### BACKGROUND

In fiber optics, a cladding mode stripper causes light propagating in the cladding to exit the cladding by absorbing the light or directing the light out of the cladding. In many optical fibers, the cladding mode stripper is a high-index polymer coated onto a lower-index cladding. When light propagating in the cladding hits the cladding/polymer interface, it refracts out of the cladding and into the polymer.

Cladding mode strippers are especially useful in high-power fiber lasers and amplifiers. In a high-power fiber laser or laser, the cladding guides high-power pump light that amplifies a seed or signal beam propagating in the fiber core doped with a gain medium, such as erbium or ytterbium. The gain medium doesn't absorb all of the pump light, so the cladding stripper removes any remaining pump light, plus any light that escapes from the core, including fluorescence and amplified seed or signal light.

Unfortunately, polymer cladding strippers are not suitable for stripping higher-power modes out of a cladding: at high enough powers (e.g., hundreds of watts or more), the light stripped out of the cladding causes the polymer to melt or combust, ruining the optical fiber. Surrounding the cladding with liquid is not practical either because the pump light boils away the liquid. In addition, a liquid would need a refractive index higher than the cladding's refractive index, necessitating a sealed flow system around the fiber. This sealed flow system would add undesired complexity, cost, size, and weight.

FIG. 1 illustrates a pump dump 100 that circumvents the problems with polymer cladding mode strippers and liquid mode strippers and is suitable for use in high-power fiber amplifiers and lasers. The pump dump 100 includes an optical fiber 102 that with a core 110 that guides a seed or signal beam (not shown) and a cladding 120 that guides a high-power pump beam 121. A plastic coating 130 protects the fiber 102. A portion of the plastic coating 130 is removed to expose a portion 122 of the cladding 120. The exposed portion 122 of the cladding 120 is etched with ammonium/sodium bifluoride paste to produce a rough outer surface 124. The rough outer surface 124 has a frosted appearance because its features (e.g., the pits and valleys created by the etching) are about 10 microns to about 100 microns in height and about 10 microns to about 100 microns in radius.

The rough outer surface 124 acts as a Lambertian emitter. When the pump beam 121 impinges on the rough outer surface 124, the rough outer surface 124 scatters the pump beam 121 over a wide range of random angles as shown in FIG. 1. The scattered light 123 is absorbed by a tubular absorber 140, such as a metal pipe, that is thermally disconnected from the optical fiber 102. Because the metal 140 is thermally isolated from the optical fiber 102, the pump beam 121 exits the optical fiber 102 without heating the optical fiber 102, mitigating the problems associated with polymer and liquid cladding mode strippers.

Unfortunately, the pump dump 100 shown in FIG. 1 is too brittle for many applications. Etching the outer surface of the cladding 120 weakens the optical fiber 102 by creating micro- and macro-cracks and fissures. These cracks and fissures propagate through the optical fiber 102 in response to vibrations, causing the optical fiber 102 to break. When the optical fiber 102 is suspended in a metal pipe, it tends to vibrate readily, like a guitar string, making the pump dump 100 prone to breaking in applications without significant vibration dampening. For more information on the pump dump 100 shown in FIG. 1, see U.S. Pat. No. 8,433,161 B2, entitled “All Glass Fiber Laser Cladding Mode Stripper,” which is incorporated by reference herein in its entirety.

### SUMMARY

Embodiments of the present technology include an optical fiber comprising a core and a cladding disposed about the core. The core guides a first beam at a first wavelength, and the cladding guides a second beam at a second wavelength. A portion of the cladding's outer surface is textured with features smaller than the second wavelength to frustrate total internal reflection of the second beam at the outer surface of the cladding.

The features on the outer surface of the cladding may be distributed randomly across the portion of the outer surface. Their heights may be between the second wavelength and half the second wavelength. They may cause the second beam to exit the cladding without reflecting at the portion of the outer surface of the cladding.

This optical fiber may be disposed within a tubular absorber, such as a metal pipe, whose inner diameter is smaller than the outer diameter of the optical fiber. The tubular absorber can be thermally isolated from the optical fiber and configured to absorb at least some of the second beam exiting the cladding. In addition, the optical fiber may be coupled to a laser and a pump diode via a gain fiber. In operation, the laser emits the first beam, the pump diode emits the second beam, and the gain fiber guides the first and second beams to the optical fiber and amplifies the first beam.

Additional embodiments include a method comprising guiding a pump beam through a first portion of a cladding of an optical fiber. The pump beam amplifies another beam propagating through a core of the optical fiber as it propagates through the first portion of the cladding. This method also includes frustrating total internal reflection of the pump beam at an outer surface of a second portion of the cladding of the optical fiber so as to cause the pump beam to exit the optical fiber.

In some cases, frustrating total internal reflection of the pump beam at the outer surface of the second portion of the cladding includes impinging, by the pump beam, features smaller than a wavelength of the pump beam. These features can be distributed randomly across the portion of the outer surface. The features can have heights of between the wavelength of the pump beam and half the wavelength of the pump beam.

The pump beam can exit the cladding without reflecting at the portion of the outer surface of the cladding.

If desired, a tubular absorber may disposed circumferentially about the second portion of the cladding may absorb the pump beam. This tubular absorber can have an inner diameter greater than an outer diameter of the cladding. The tubular absorber may be thermally isolated from the optical fiber. The method can also include launching the other beam into a core of the optical fiber and launching the pump beam into the cladding.

Yet another embodiment includes an optical fiber with a core, a cladding disposed about the core, and an anti-reflection (AR) coating disposed about a portion for the cladding. In operation, the core guides a first beam at a first wavelength. The cladding guides a second beam at a second wavelength. And the AR coating frustrates total internal reflection of the second beam at an interface between the cladding and the anti-reflection coating. For example, the AR coating may cause the second beam to exit the cladding without reflecting at the interface between the cladding and the anti-reflection coating.

This optical fiber may be disposed within a tubular absorber, such as a metal pipe, whose inner diameter is smaller than the outer diameter of the optical fiber. The tubular absorber can be thermally isolated from the optical fiber and configured to absorb at least some of the second beam exiting the cladding. In addition, the optical fiber may be coupled to a laser and a pump diode via a gain fiber. In operation, the laser emits the first beam, the pump diode emits the second beam, and the gain fiber guides the first and second beams to the optical fiber and amplifies the first beam.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows a prior-art fiber-optic pump dump with roughly etched surface for stripping light out of the cladding.

FIG. 2 shows an inventive fiber-optic pump dump with a nanotextured anti-reflection (AR) surface that directs light out of the cladding by frustrating total internal reflection at the air/cladding interface.

FIG. 3A is a schematic diagram of an example randomly nanotextured AR surface for use in an inventive fiber-optic pump dump.

FIG. 3B is a micrograph of an example randomly nanotextured AR surface for use in an inventive fiber-optic pump dump.

FIG. 4 shows an inventive fiber-optic pump dump with a dielectric AR film coating that directs light out of the cladding by frustrating total internal reflection at the air/cladding interface.

FIG. 5 shows a high-power fiber amplifier with an inventive pump dump.

FIG. 6 is a flowchart illustrating a method of stripping light from a cladding using a nanotextured AR surface or multi-layer, dielectric AR film coating.

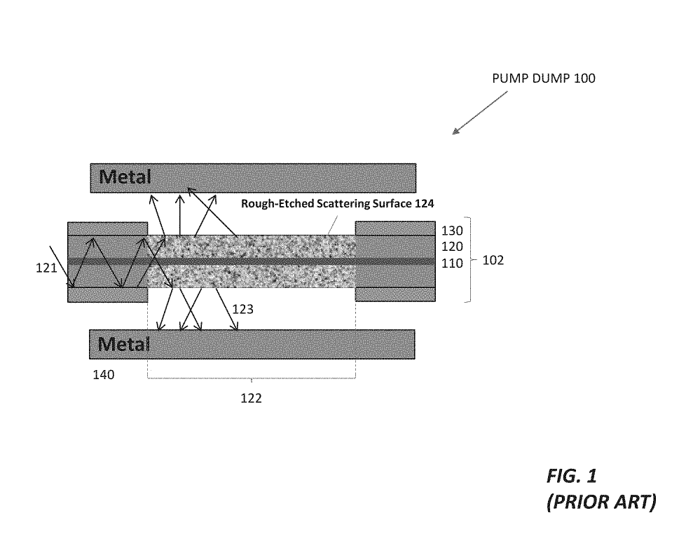

### DETAILED DESCRIPTION

Texturing the outer surface of the cladding of an optical fiber with sub-wavelength-scale features removes cladding light without heating the optical fiber or its surroundings and without making the fiber susceptible to cracks or fissures. This texturing may be random and can be applied to the cladding's outer surface using reactive ion etching (ME). RIE yields nanometer-sized features distributed randomly across the cladding's outer surface without creating cracks or fissures large enough to propagate across the optical fiber, preserving the optical fiber's native strength. (Glass and bulk optical components with similar texturing are available from TelAztec LLC of Burlington, Mass. (www.telaztec.com).) And because these features are so small, the cladding's outer surface appears clear rather than frosted.

When used as a pump dump or cladding mode stripper in a high-power fiber laser or amplifier, the cladding's nanotextured outer surface frustrates total internal reflection of pump light propagating in the cladding. Put differently, the nanotextured outer surface acts as an anti-reflecting (AR) coating: a pump beam propagating in the cladding refracts across the cladding/air interface (the nanotextured outer surface) instead of reflecting back into the cladding. Without being bound by any particular theory, it appears that the pump beam may propagate in air at an angle depending, at least in part, on the refractive indices of air and the cladding at the pump wavelength.

An optical fiber with a nanotextured cladding surface has several advantages over other cladding mode strippers. Neither the cladding nor its nanotextured surface absorbs the pump light, so the pump light does not heat the optical fiber appreciably as it exits the cladding, unlike polymer cladding mode strippers. And the nanotextured outer surface is smoother and has fewer imperfections than a rougher outer surface, making the optical fiber less likely to break if perturbed. ME is also less hazardous than the etching process used to create rougher surfaces. These advantages make an optical fiber with a nanotextured cladding surface especially suitable for stripping high-power cladding modes in a fiber laser or fiber amplifier.

A Pump Dump with an Anti-Reflection (AR) Nanotextured Cladding Outer Surface

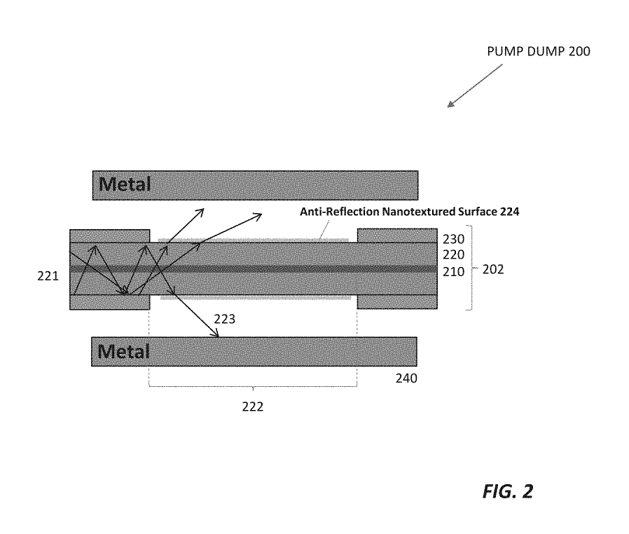

FIG. 2 shows a pump dump 200 with an AR nanotextured cladding outer surface 224. The pump dump 200 includes an optical fiber 202 that with a core 210 that guides a seed or signal beam (not shown) and a cladding 220 that guides a high-power pump beam 221. The cladding 220 is surrounded by a plastic coating 230 that protects the optical fiber 202 from being bent, nicked, or broken.

A portion of the plastic coating 230 is removed to expose a portion 222 of the inner cladding 220. The exposed portion 222 of the inner cladding 220 is etched with RIE or another suitable technique to produce the AR nanotextured outer surface 224. To the eye, the AR nanotextured outer surface 224 appears clear, not frosted, because its features (e.g., the pits and valleys created by the etching) are, on average, less than the pump wavelength in height and radius.

The AR nanotextured outer surface 224 extend across part or all of the circumference of the optical fiber 202. The length of the AR nanotextured outer surface 224 can be determined empirically as it depends on the AR coating performance and the desired attenuation. Typically, the AR nanotextured outer surface 224 is positioned on a gain fiber (i.e., the optical fiber 202 would be a gain fiber) or positioned a certain distance after a gain fiber (not shown). The separation between the end of the gain fiber and the beginning of the AR nanotextured outer surface 224 depends on the desired pump absorption: for 13 dB of pump absorption in Nufern ytterbium-doped gain fiber with a 20-micron diameter core and 400-micron cladding, the distance is about 10 meters.

A tubular absorber 240, such as a metal pipe, surrounds the nanotextured portion of the optical fiber 201. This tubular absorber 240 is thermally isolated from the optical fiber 201—they may not touch each other or may be connected via a thermal insulator—and absorbs light at the pump wavelength. The tubular absorber 240 may also absorb light at other wavelengths stripped from the cladding 210 by the subwavelength-scale features on the exposed portion 222 of the cladding 210.

### An AR Nanotextured Cladding Outer Surface

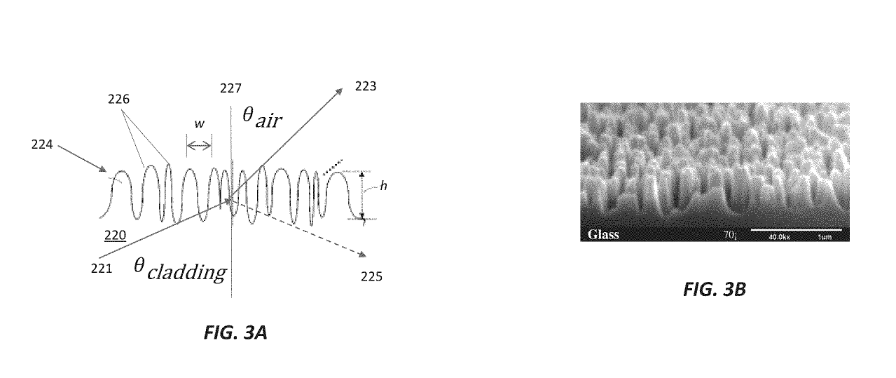

FIGS. 3A and 3B show the AR nanotextured outer surface 224 of the pump dump 200 of FIG. 2 in greater detail. FIG. 3A shows a cross-sectional profile of a portion of the AR nanotextured outer surface 224. And FIG. 3B is a micrograph of a similar AR nanotextured outer surface on a piece of glass. Both figures show that the AR nanotextured outer surface 224 has randomly arrayed surface relief features 226 distributed with relatively uniform density. These features 226 may protrude from the cladding surface as generally conical features or form conical depressions or blind holds in the cladding surface.

The features 226 have heights h that are between about λ/2 and λ and widths w that are less than A, where A is the wavelength of the pump beam. For ytterbium-doped amplifiers, the pump beam wavelength is about 915-980; for erbium-doped amplifiers, the pump wavelength is 980 nm or 1480 nm; and for thulium-doped amplifiers, the pump wavelength is 793 nm or 1570 nm. This translates to features that are about 400 nm to about 1600 nm high (e.g., about 500, 750, 800, or 1000 nm high) and less than 1600 nm wide (e.g., about 1500, 1400, 1300, 1200, 1100, 1000, 900, 800, 700, 600, 500, or 400 nm wide). For more information on the AR nanotextured outer surface 224 and how to make it, see, e.g., U.S. Pat. No. 8,187,481 B1, which is entitled “Random Texture Anti-Reflection Optical Surface Treatment” and is incorporated herein by reference in its entirety.

FIG. 3A illustrates how the pump beam 221 interacts with the AR nanotextured outer surface 224. The pump beam 221 propagates along the cladding 220 at angle within the numerical aperture (NA) of the optical fiber 201. The pump beam 221 totally internally reflects off the untextured (normal) portions of the cladding's outer surface, propagates through the core 210, and so on until it reaches the AR nanotextured outer surface 224. Instead of totally internally reflecting at the interface between the AR nanotextured outer surface 224 and the air surrounding the optical fiber 201 (and following path 225), the pump beam 221 exits the cladding 220 at angle with respect to surface normal 227. This angle may depend on the refractive index of the cladding, the refractive index of the medium surrounding the cladding (e.g., air), and the angle that the pump beam 221 forms with the surface normal 227 in the cladding 220.

The randomly distributed, subwavelength-scale features on the AR nanotextured outer surface 224 frustrate total internal reflection by the pump beam 221. They do not absorb an appreciable amount of pump light, so the pump beam 221 simply propagates out of the cladding without being absorbed, scattered, or reflected. In other words, the AR nanotextured outer surface 224 strips pump light guided by the cladding 220 without heating the optical fiber 201.

A Pump Dump with a Dielectric AR Coating

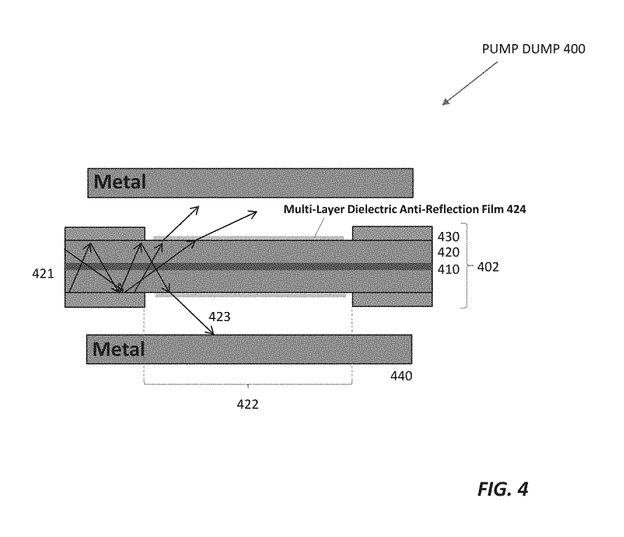

FIG. 4 shows a pump dump 400 with a dielectric AR coating 424 that strips cladding modes from an optical fiber 401. The dielectric AR coating 424 is disposed circumferentially about an exposed section 422 of the optical fiber's cladding 220, which in turn is disposed circumferentially about a core 410. A plastic coating 230 surrounds the rest of the cladding 220 to prevent the optical fiber 401 from being nicked or broken. The optical fiber 401 runs down the center of a pipe 440 made of metal or another absorptive material. The pipe's inner diameter is larger than the optical fiber's outer diameter, and the pipe 440 is thermally isolated from the optical fiber 401.

The dielectric AR coating 424 comprises one or more layers of dielectric material deposited on the cladding's outer surfaces. The number of layers, layer thickness, and layer material are selected to cancel reflections at the pump light through destructive interference. A single-layer dielectric AR coating 424 has an optical thickness equal to an odd multiple of λ/4, where λ is the pump wavelength. At this optical thickness, the relative phase shift between the pump beam 421 reflected at the upper and lower boundaries of the dielectric AR coating 424 is 180°. And at this phase shift, the reflected portions of the pump beam 421 destructively interfere with each other, frustrating total internal reflection at the outer surface of the cladding 420.

In operation, the core 410 guides a signal or seed beam (not shown) and the cladding 420 guides a pump beam 421. If the core 410 is doped with a gain medium (e.g., erbium, ytterbium, or thulium) or the optical fiber 401 is optically coupled to a gain fiber (not shown), the pump beam 421 amplifies the beam propagating through the core 410. When the pump beam 421 reaches the pump dump section 422 of the cladding 420, it impinges on the AR film 424, which prevents light at the pump wavelength from reflecting back into the cladding 420 and toward the core 410. Put differently, the AR film 424 acts as a notch filter that transmits pump light 423 and reflects light at other wavelengths. If desired, the AR film's passband may be engineered to transmit light at other wavelengths, including the signal/seed wavelength. This allows the AR film 424 to strip light that escapes from the core 410 into the cladding 420 from the cladding 420 as well.

A High-Power Fiber Amplifier with an AR Pump Dump

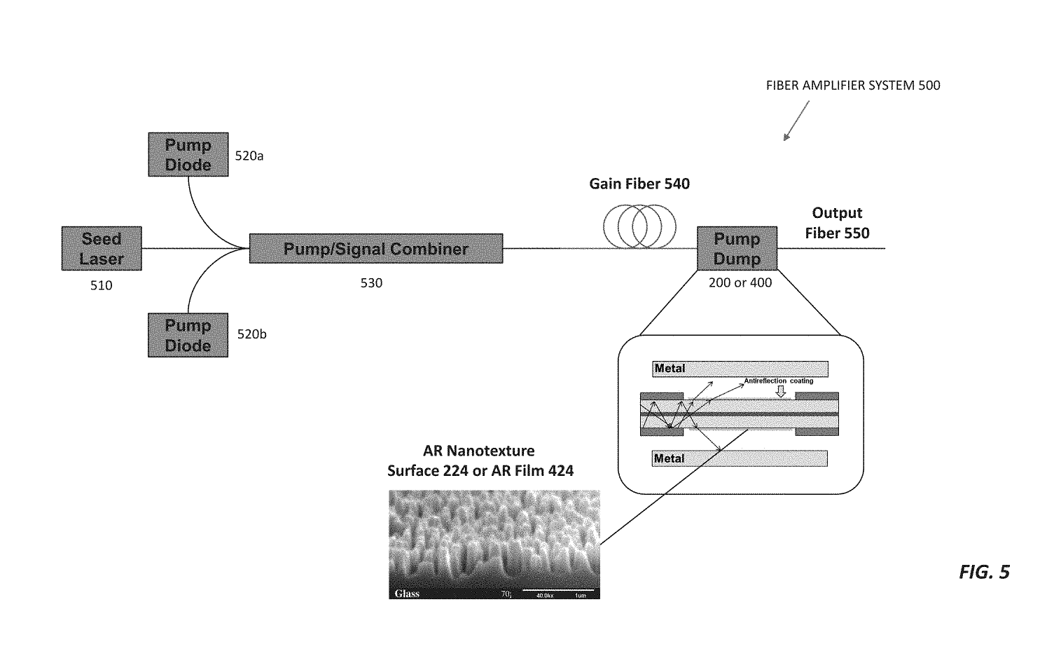

FIG. 5 shows a high-power fiber amplifier 500 with a pump dump 200/400 for stripping the pump beam from the cladding before the amplifier output. The amplifier 500 includes a seed laser 510 and one or more pump diodes (here, pump diodes 520a and 520b) that are coupled to a pump/signal combiner 530. The output of the pump/signal combiner 530 is coupled to a gain fiber 540, which may be doped with ytterbium, erbium, thulium, or another suitable dopant. The gain fiber 540 is coupled to the pump dump 200/400, which in turn is coupled to an output fiber 550.

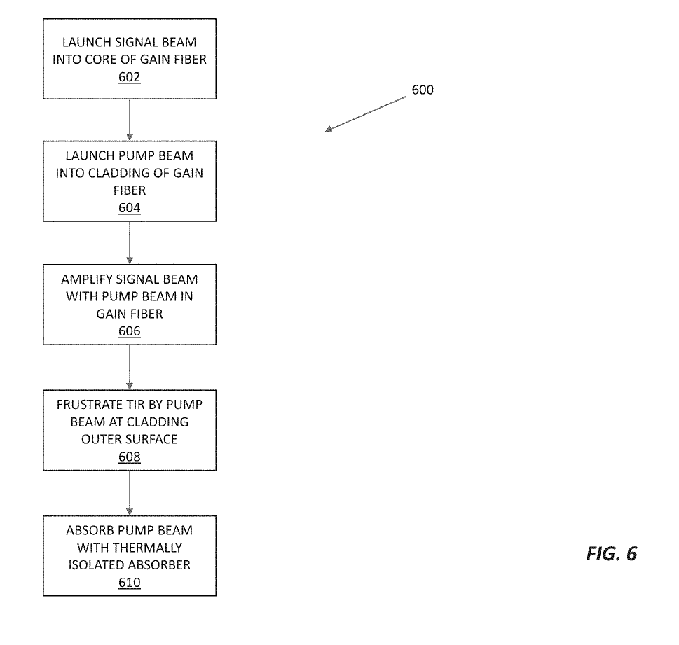

FIG. 6 illustrates a process 600 for operating the fiber amplifier 500 shown in FIG. 5. The laser 510 launches a signal or seed beam, which may be at a wavelength of 1030-1070 nm, 1525-1570 nm, or 1800-2000 nm, depending on the dopant of the gain fiber 540, into the core of the gain fiber 540 via the beam combiner 530 (step 602). The pump diode(s) 520a and 520b launch one or more pump beams, which may be at wavelengths of 793 nm, 915-980 nm, or 1480 nm, depending on the dopant of the gain fiber 540, into the cladding of the gain fiber 540 via the beam combiner 530 (step 604).

As the signal and pump beams propagate through the gain fiber 540, the pump beam amplifies the signal beam (step 606). When the pump beam reaches the pump dump 200/400, it hits subwavelength features or an AR film on the cladding's outer surface. The subwavelength features or AR film prevents the pump beam from total internally reflecting at the interface between the cladding and the surrounding medium (e.g., air) (step 608). Rather than reflecting at this interface, the pump light propagates across the interface, bending as though refracting at the interface.

The transmitted pump light propagates an air gap until it hits an absorber, such as a metal pipe disposed circumferentially about the optical fiber, that does not transmit heat to the optical fiber (step 610). This absorber absorbs the pump light leaving the cladding without heating the optical fiber in the pump dump. In other words, the fiber in the pump dump should be essentially room temperature, as there is no absorption of the pump light from the pump dump process. The tubular absorber surrounding the optical fiber may get hot. It will likely be hotter at the beginning than at the end, as the higher angle rays will be stripped out quickly and the lower angle rays will propagate in the dump a greater distance before being stripped out.

The “steps” in the process 600 of FIG. 6 are not necessarily discrete, nor do they have to occur in the order shown in FIG. 6. In fact, they can occur simultaneously, e.g., with the laser 510 and pump diodes 520a and 520b launching continuous-wave beams into the input end of the gain fiber 540 via the combiner 530 while the pump dump 200/400 strips modes out of the cladding at the far end of the gain fiber 540. The fiber amplifier can also operate in pulsed mode, where the laser 510 and possibly the pump diodes 520a and 520b are pulsed on and off. Other variations are also possible, e.g., with the “pump dump” formed in a portion of the gain fiber 540 itself.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of.” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An optical fiber comprising:
a core to guide a first beam at a first wavelength;
a cladding, disposed about the core, to guide a second beam at a second wavelength, the cladding having an outer surface,
wherein a portion of the outer surface is textured with features smaller than the second wavelength to frustrate total internal reflection of the second beam at the outer surface of the cladding.

2. The optical fiber of claim 1, wherein the features are distributed randomly across the portion of the outer surface.

3. The optical fiber of claim 1, wherein the features have heights of between the second wavelength and half the second wavelength.

4. The optical fiber of claim 1, wherein the features cause the second beam to exit the cladding without reflecting at the portion of the outer surface of the cladding.

5. A system comprising:
a tubular absorber; and
the optical fiber of claim 1 disposed within the tubular absorber, the optical fiber having an outer diameter smaller than an inner diameter of the metal tube.

6. The system of claim 5, wherein the tubular absorber is thermally isolated from the optical fiber and configured to absorb at least some of the second beam exiting the cladding.

7. The system of claim 6, further comprising:
a laser to emit the first beam;
a pump diode to emit the second beam;
a gain fiber, in optical communication with the laser, the pump diode, and the optical fiber, to amplify the first beam, to guide the first beam to the optical fiber, and to guide the second beam to the optical fiber.

8. A method comprising:
guiding a pump beam through a first portion of a cladding of an optical fiber, the pump beam amplifying another beam propagating through a core of the optical fiber; and
frustrating total internal reflection of the pump beam at an outer surface of a second portion of the cladding of the optical fiber so as to cause the pump beam to exit the optical fiber.

9. The method of claim 8, wherein frustrating total internal reflection of the pump beam at the outer surface of the second portion of the cladding comprises:
impinging, by the pump beam, features smaller than a wavelength of the pump beam.

10. The method of claim 9, wherein the features are distributed randomly across the portion of the outer surface.

11. The method of claim 9, wherein the features have heights of between the wavelength of the pump beam and half the wavelength of the pump beam.

12. The method of claim 8, wherein the pump beam exits the cladding without reflecting at the portion of the outer surface of the cladding.

13. The method of claim 8, further comprising:
absorbing the pump beam with a tubular absorber disposed circumferentially about the second portion of the cladding, the metal tube having an inner diameter greater than an outer diameter of the cladding.

14. The method of claim 13, further comprising:
thermally isolating the metal tube from the optical fiber.

15. The method of claim 8, further comprising:
launching the other beam into a core of the optical fiber; and
launching the pump beam into the cladding.

16. An optical fiber comprising:
a core to guide a first beam at a first wavelength;
a cladding, disposed about the core, to guide a second beam at a second wavelength; and
an anti-reflection (AR) coating, disposed about a portion of the cladding, to frustrate total internal reflection of the second beam at an interface between the cladding and the anti-reflection coating.

17. The optical fiber of claim 16, wherein the AR coating causes the second beam to exit the cladding without reflecting at the interface between the cladding and the anti-reflection coating.

18. A system comprising:
a tubular absorber; and
the optical fiber of claim 16 disposed within the tubular absorber, the optical fiber having an outer diameter smaller than an inner diameter of the metal tube.

19. The system of claim 18, wherein the tubular absorber is thermally isolated from the optical fiber and configured to absorb at least some of the pump beam exiting the cladding.

20. The system of claim 18, further comprising:
a laser to emit the first beam;
a pump source to emit the second beam;
a gain fiber, in optical communication with the laser, the pump source, and the optical fiber, to amplify and guide the first beam to the optical fiber and to guide the second beam.
